(19) United States
(12) Patent Application Publication
(10) Pub. No.: US 2006/0067759 A1
(43) Pub. Date: Mar. 30, 2006

(54) Data-processing apparatus and data-processing method for generating copy-forgery-inhibited pattern image, and control program

(75) Inventor: Hitoshi Osaka, Yokohama-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/238,798

(22) Filed: Sep. 29, 2005

(30) Foreign Application Priority Data
Sep. 30, 2004 (JP) 2004-287654(PAT.)
Sep. 22, 2005 (JP) 2005-275947(PAT.)

(51) Int. Cl. G03G 21/00

(52) U.S. Cl. 399/366

(57) ABSTRACT

A data-processing apparatus for generating a copy-forgery-inhibited pattern image including a plurality of individual character strings includes an accepting unit that accepts specifications for the plurality of character strings, a drawing-attribute accepting unit that accepts specifications for drawing attributes for the individual character strings, a calculating unit that calculates lengths of the individual character strings based on the specifications accepted by the accepting unit and the drawing-attribute accepting unit, and a generating unit that generates character string lines by combining the plurality of character strings based on the lengths of the individual character strings calculated by the calculating unit.

### BACKGROUND OF THE INVENTION

1. Field of the Invention

The present invention relates to a mechanism for generating patterns. The present invention can be applied to, for example, generating copy-forgery-inhibited pattern images that suppress illegal copying.

2. Description of the Related Art

Hitherto, paper on which a special print is made called anti-forgery paper for suppressing copying of the paper has been used to make, for example, resident cards and negotiable instruments such as certificates. A predetermined character string on an original anti-forgery paper is illegible. When a copy of the original anti-forgery paper is made using a copying machine or the like, the predetermined characters, for example, “COPY”, appear clearly on the copy. Thus, an original document can be visually distinguished from a copy of the original document with ease. With this anti-forgery paper, a person who had made a copy would hesitate to use the copy. Moreover, the anti-forgery paper has a psychological effect of suppressing illegal copying itself.

A predetermined character string on an original anti-forgery paper needs to be illegible to persons because the original paper needs to be clearly distinguishable from a copy. If a predetermined character string, for example, “COPY”, appeared clearly on the original paper such that persons could clearly recognize the character string, this original paper might be wrongly identified as a copy and the anti-forgery paper would not work as required.

Techniques for manufacturing such anti-forgery paper are disclosed in, for example, U.S. Pat. No. 5,788,285 to Wicker and U.S. Pat. No. 6,000,728 to Mowry.

Unfortunately, the cost of manufacturing anti-forgery paper is disadvantageously higher than that of manufacturing ordinary paper because anti-forgery paper is manufactured utilizing a special printing technique. Moreover, only predetermined characters that are set during the manufacture of anti-forgery paper appear clearly on a copy. Thus, applications of anti-forgery paper, predetermined character strings that are set, and the like, are restricted. That is to say, known anti-forgery paper lacks flexibility in its applications due to the manufacturing process.

In this environment, a technique for printing paper having the same effect as known anti-forgery paper on demand using a computer and a printer has attracted attention. This technique is largely based on the significant improvement in printer performance that has occurred in recent years. A technique for printing an image termed a copy-forgery-inhibited pattern image superimposed on a background of content data created using a computer upon printing the content data using a printer is disclosed in Japanese Patent Laid-Open Nos. 2001-197297 and 2001-238075. The copy-forgery-inhibited pattern image appears on an original document (paper printed by a printer) as, for example, a pattern or a background color, and appears clearly on a copy of the original document as, for example, predetermined characters. The copy-forgery-inhibited pattern image has the same effect of suppressing illegal copying as anti-forgery paper.

When a copy-forgery-inhibited pattern image that is created using a computer and superimposed on content data is printed, ordinary printing paper can be used. Thus, this provides advantages in terms of cost compared with anti-forgery paper. Moreover, the copy-forgery-inhibited pattern image can be generated when the content data is printed. Thus, predetermined characters and the like that appear clearly on a copy can be freely set. Conveniently, variable information such as the name of a user who executes the printing and the date of printing may appear clearly on a copy as predetermined character strings.

As described above, when the copy-forgery-inhibited pattern image is copied, predetermined characters and the like that are incognizable before copying appear clearly on the copy. This suppresses the use of the copy and the document can be visually recognized with ease to be a copy, i.e., not an original document. To achieve these effects, the copy-forgery-inhibited pattern image basically includes the following two regions: a first region in which an image appears clearly on a copy, and a second region in which an image does not appear on a copy or becomes hard to recognize because the color of this image is lighter than that in the first region. In a printed paper, these two regions have substantially the same color density, and persons cannot recognize at a glance predetermined characters, for example, “COPY”, and the like that are hidden (embedded) and that are to appear clearly on a copy.

Hereinafter, an image that is to appear on a copy is called a latent image, and an image that is to not appear on a copy or becomes light on a copy is called a background image. The copy-forgery-inhibited pattern image basically includes the latent image and the background image. In some cases, the latent image may be called a foreground image that is used as a term in the field of user interface design.

Copy-forgery-inhibited pattern printing is not limited to that described above, and can take other forms so long as a predetermined character string, for example, “COPY”, a logo, a pattern, or the like appears clearly on a copy so that they can be recognized by persons. That is to say, even when a predetermined character string, for example, “COPY”, is reverse-printed on a copy, the purpose of the copy-forgery-inhibited pattern printing is achieved. In this case, needless to say, the character string “COPY” is generated as a background image.

As disclosed in the documents described above, in a typical printing system that can print a copy-forgery-inhibited pattern, a predetermined character string may be set in a copy-forgery-inhibited pattern as a latent image. The character string may be set by being selected from a number of predetermined options, by a user freely inputting a character string, by automatically retrieving identification data, for example, an IP address or a computer name of the printing system, or by retrieving variable data, for example, the printing time. A plurality of character strings may be set as a latent image.

In typical copy-forgery-inhibited pattern printing, a copy-forgery-inhibited pattern is often printed on the entire surface of a sheet to be printed. Alternatively, a copy-forgery-inhibited pattern may be printed only on a specific region. In both cases, as many copy-forgery-inhibited patterns as are required to cover a predetermined area are generated. As disclosed in Japanese Patent Laid-Open No. 2001-197297, particularly, in FIG. 17, in many cases, a copy-forgery-inhibited pattern image is generated by setting a region including a predetermined latent character string as a unit and then repeatedly disposing as many regions as are required to cover a predetermined area.

As described above, one of the purposes of the copy-forgery-inhibited pattern is to achieve an effect of suppressing copying of a printed document by disposing a predetermined latent character string. Moreover, a deterrent effect of making forgery of the content of a document more difficult can be achieved by printing a predetermined latent character string so as to be superimposed on the content. Moreover, an advantage can be achieved, in which the route of an outflowing copy can be identified by setting fixed or variable data as a predetermined latent character string.

To reliably achieve these effects and advantage, predetermined latent character strings in copy-forgery-inhibited patterns need to be disposed on a sheet to be printed so as to efficiently occupy the space of the sheet. The same applies to a printing system that generates a copy-forgery-inhibited pattern on demand.

Here, for the case described above where a character string to be a latent image can be freely set, a typical arrangement of copy-forgery-inhibited patterns will now be examined. In this arrangement, a plurality of character strings are grouped as one group, and as many groups as are required to cover an area, for example, an entire surface of a sheet, in which copy-forgery-inhibited patterns are set, are disposed.

In FIG. 17, a typical arrangement is shown. In this arrangement, a copy-forgery-inhibited pattern image is generated by disposing copy-forgery-inhibited pattern image blocks 1701 so as to be arranged like tiles on an area 1702 that is assumed to be an entire surface of a sheet. Each block 1701 is generated so as to include two types of predetermined character strings “COPY” and “VOID” as one group. The predetermined character strings “COPY” and “VOID” have the same number of characters and substantially the same font size, and are arranged horizontally. Thus, the predetermined latent character strings are arranged on the area so as to leave negligibly small gaps. As described above, when the copy-forgery-inhibited pattern image blocks are disposed on a predetermined area with substantially no gaps, the visibility of the predetermined latent character strings on a copy is improved.

However, in a printing system that prints a copy-forgery-inhibited pattern on demand, one of the advantages is that users can freely set the length, the font size, and the arrangement angle of a character string. In some cases, when variable data is set as a predetermined latent character string, the content of the character string, the number of characters (the length), and the like are not determined until print data is generated and sent to a printer.

FIG. 18 shows a case where three types of predetermined latent character strings “Warning: This Paper is copied”, “IP Add”, and “UserLoginName” are printed according to user designation. These strings have the same font size and are arranged at an angle of 30° with respect to the horizontal direction. The IP address of a computer that performs the printing operation is dynamically set at the position of “IP Add”. The login name of a user that executes the printing operation is dynamically set at the position of “UserLoginName”. In this case, the size of a group 1801 is variable depending on the content of the character strings, which are dynamically set. In a known printing system, the block size is defined so as to accommodate a user-specified character string and a character string that is dynamically obtained, considering the font sizes, the arrangement angles, and the like, and then an optimal block arrangement is determined on the basis of this block size and the size of an area on which copy-forgery-inhibited patterns are disposed. However, many background areas (space) that include no predetermined latent character strings may occur when the blocks are repeatedly disposed, due to different lengths and the content of the predetermined latent character strings, and the like. In this case, the user cannot recognize the occurrence of space unless the user takes a copy of an actual printed document using a copying machine. Obviously, when various types of settings are changed so as to decrease the amount of space, the user needs to repeatedly take a copy of an actual printed document to test for the occurrence of space in the same way, which is troublesome. In some cases, the user must abandon the user's desired selections of character strings.

### SUMMARY OF THE INVENTION

To solve the problems described above, the present invention provides a mechanism for efficiently disposing objects, for example, character strings, without bothering users.

According to an aspect of the present invention, a data-processing apparatus for generating a copy-forgery-inhibited pattern image including a plurality of individual character strings includes an accepting unit configured to accept specifications for the individual character strings, a drawing-attribute accepting unit configured to accept specifications for drawing attributes for the individual character strings, a calculating unit configured to calculate lengths of the individual character strings based on the specifications accepted by the accepting unit and the drawing-attribute accepting unit, and a generating unit configured to generate character string lines by combining the individual character strings based on the lengths of the individual character strings calculated by the calculating unit.

According to another aspect of the present invention, a copy-forgery-inhibited pattern image generating apparatus that generates a copy-forgery-inhibited pattern image including a plurality of character strings includes a generating unit configured to generate a third character-string group by combining a first character-string group including character strings arranged in decreasing order of length and a second character-string group including character strings arranged in increasing order of length with a predetermined amount of space between the first character-string group and the second character-string group, and an arranging unit configured to generate the copy-forgery-inhibited pattern image by disposing the third character-string group generated by the generating unit like tiles on a predetermined area.

According to another aspect of the present invention, an image-generating apparatus that generates an output pattern including a plurality of character strings includes an accepting unit configured to accept input of a plurality of character strings, a determining unit configured to determine a combination string including a plurality of character strings accepted by the accepting unit so that few gaps occur based on lengths of the individual character strings, and a generating unit configured to generate the output pattern by repeatedly disposing the combination string determined by the determining unit.

According to yet another aspect of the present invention, an image-generating apparatus that generates a pattern including a plurality of character strings includes an accepting unit configured to accept input of a plurality of character strings, a determining unit configured to select at least one character string from the plurality of character strings accepted by the accepting unit so that a total length of the at least one character string is close to a reference length, and an arranging unit configured to generate the pattern by disposing the at least one character string selected by the determining unit and disposing a character string other than the selected at least one character string so that a total length of the character string is close to the reference length.

According to still another aspect of the present invention, an image-generating apparatus that generates a character-string pattern includes an accepting unit configured to accept input of a plurality of character strings, a determining unit configured to select one character string from the plurality of character strings accepted by the accepting unit as a character string to be used multiple times, and a generating unit configured to generate the character-string pattern by disposing a plurality of copies of the character string selected by the determining unit.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments of the invention and, together with the description, serve to explain the principles of the invention.

FIG. 1 is a block diagram showing an exemplary structure of a typical system according to a first embodiment of the present invention.

FIG. 2 is a view showing an exemplary structure of a typical host computer for print processing shown in FIG. 1.

FIG. 3 is a view showing an exemplary dialog screen for inputting print settings.

FIG. 4 is a view showing an exemplary dialog screen for inputting print settings.

FIGS. 5A and 5B show images when a known arrangement process of character strings is performed.

FIGS. 6A, 6B, and 6C show typical images when an arrangement process of character strings according to the first embodiment of the present invention is performed.

FIG. 7 is a view showing a state in which the character-string block image shown in FIG. 6B is disposed like tiles.

FIG. 8 is a flowchart showing exemplary copy-forgery-inhibited pattern image generation according to the first embodiment of the present invention.

FIG. 9 is a view showing a typical character-string control table according to the first embodiment of the present invention.

FIG. 10 is a flowchart showing exemplary copy-forgery-inhibited pattern image block generation according to the first embodiment of the present invention.

FIG. 11 is a view showing the structure of a typical block generated by the copy-forgery-inhibited pattern image block generation.

FIG. 12 is a view showing an exemplary dialog screen for adjusting a space between character strings according to the first embodiment of the present invention.

FIG. 13 is a view showing a state in which character-string blocks are arranged like tiles in the first embodiment of the present invention.

FIG. 14 is a flowchart showing exemplary copy-forgery-inhibited pattern image block generation according to a second embodiment of the present invention.

FIG. 15 is a flowchart showing an exemplary changing process of font sizes according to the second embodiment of the present invention.

FIGS. 16A and 16B are views showing a character-string block generated in the first embodiment of the present invention and a character-string block generated in the second embodiment of the present invention, respectively.

FIG. 17 is a view showing a known copy-forgery-inhibited pattern image.

FIG. 18 is a view showing drawbacks in the known copy-forgery-inhibited pattern image.

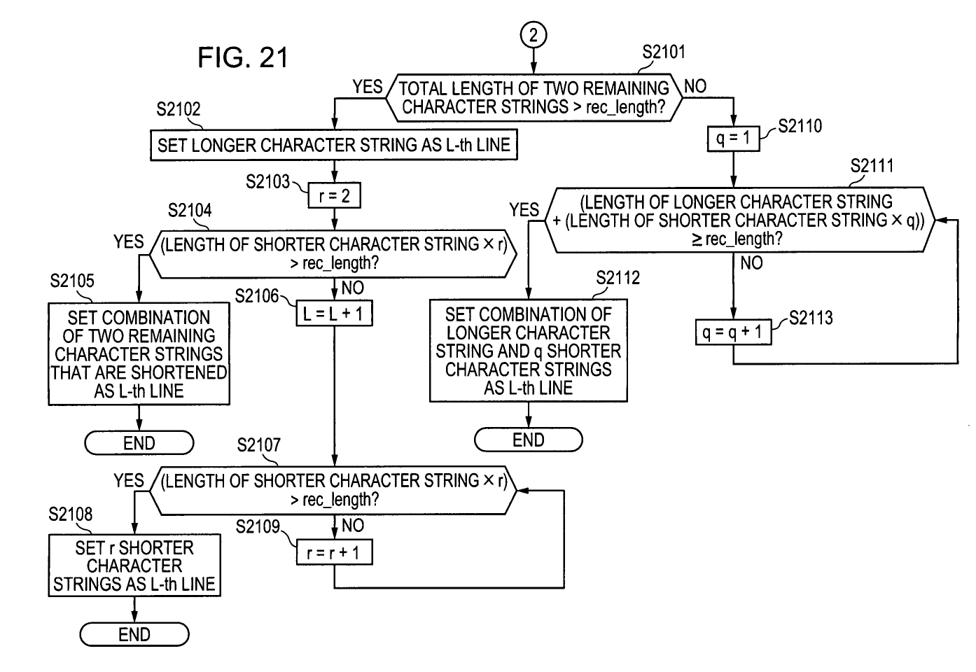

FIGS. 19-22 are a flowchart showing exemplary character-string pattern generation according to a third embodiment of the present invention.

FIGS. 23A and 23B show typical images when an arrangement process of character strings according to the third embodiment of the present invention is performed.

### DESCRIPTION OF THE EMBODIMENTS

Exemplary embodiments of the present invention will now be described in detail in accordance with the accompanying drawings. In the embodiments described below, an image that is to appear clearly on a copy is called a latent-image portion or a foreground-image portion, and an image that is to not appear on a copy or becomes light compared with the latent-image portion on a copy is called a background-image portion. Predetermined text data, for example, “COPY”, is set as the latent-image portion. However, in the present invention, a copy-forgery-inhibited pattern image is not limited to this arrangement, and predetermined text data (a latent-image portion) may appear clearly on a copy as white characters on a colored surrounding image (a background-image portion).

In the method described above for generating a copy-forgery-inhibited pattern, a latent-image portion appears clearly on a copy, and a background-image portion does not appear on a copy or becomes light on a copy. Alternatively, another method for generating a copy-forgery-inhibited pattern may be used so long as a copy of a copy-forgery-inhibited pattern can be reliably identified. For example, a copy-forgery-inhibited pattern may be generated with a dot pattern so that a moire pattern of a latent-image portion is different from that of a background-image portion on a copy.

In a copy-forgery-inhibited pattern according to the embodiments of the present invention, a latent-image portion is formed with a dot pattern including concentrated dots that is sufficiently large to be read by a copying machine, and a background-image portion is formed with dispersed dots that are too small to be read by a copying machine. Then, an image is formed so that the area gradation of the dot pattern of the latent-image portion is the same as that of the background-image portion. In this arrangement, the difference between the latent-image portion and the background-image portion is difficult to recognize at the time of printing an original document, and a copy obtained by a copying machine reading the printed original document can be identified because the latent-image portion appears clearly on the copy. However, the present invention does not depend on a dot pattern of a copy-forgery-inhibited pattern, a method for generating the dot pattern, and a method for processing images. Thus, in the present invention, various types of methods for generating an image may be used. For example, an image may be generated with numerous lines instead of dots.

### First Embodiment

A first embodiment will now be described in accordance with the accompanying drawings.

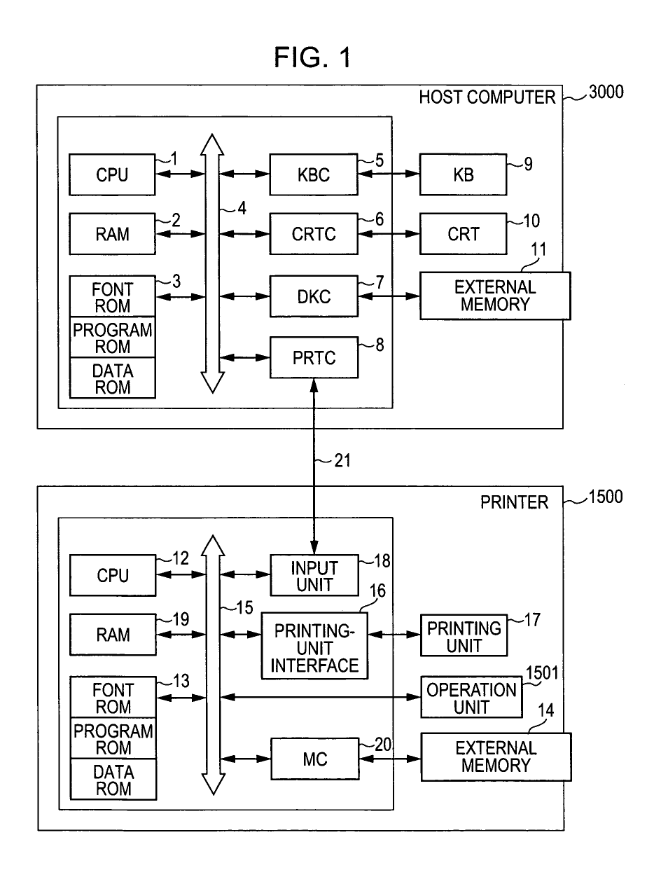

FIG. 1 is a block diagram showing an exemplary structure of a printing system according to the first embodiment. The present invention may be applied to a single device, a system including a plurality of devices, or a system in which communication through a network, for example, a local area network (LAN) or a wide area network (WAN), is established and processing is performed, so long as the functions of the present invention are performed.

In FIG. 1, a host computer 3000 includes a central processing unit (CPU) 1, a random access memory (RAM) 2, a read-only memory (ROM) 3, a system bus 4, a keyboard controller (KBC) 5, a cathode-ray tube controller (CRTC) 6, a disk controller (DKC) 7, a printer controller (PRTC) 8, a keyboard (KB) 9, a cathode-ray tube (CRT) display 10, and an external memory 11. The CPU 1 controls document processing and associated print processing, including typical processing described below according to the present invention, according to a document processing program and the like stored in a program ROM in the ROM 3 or in the external memory 11. A document including graphics, images, characters, and tables (including spreadsheets of a spreadsheet program) is subjected to this document processing. The CPU 1 also performs an overall control of components connected to the system bus 4. The program ROM in the ROM 3 or the external memory 11 stores, for example, an operating system (OS) that is a control program of the CPU 1. A font ROM in the ROM 3 or the external memory 11 stores font data and the like used in the document processing. A data ROM in the ROM 3 or the external memory 11 stores various types of data used in the document processing. The RAM 2 serves as a main memory, a work area, and the like of the CPU 1.

The KBC 5 controls an input operation from the keyboard 9 or a pointing device (not shown). The CRTC 6 controls display of the CRT display 10, including display of a copy-forgery-inhibited pattern image. The DKC 7 controls access to the external memory 11, for example, a hard disk (HD) or a floppy disk (FD), which stores a boot program, various types of applications, font data, user files, edit files, a printer control command generation program (hereinafter called a printer driver), and the like. The PRTC 8 is connected to a printer 1500 through a bidirectional interface 21 and performs communication control between the printer 1500 and the host computer 3000.

The CPU 1 performs rendering (rasterizing) of outline fonts in a display data RAM included in the RAM 2 and enables WYSIWYG (what you see is what you get) on the CRT display 10. The CPU 1 also opens various types of registered windows according to a command designated with, for example, a mouse cursor (not shown) on the CRT display 10 to perform various types of data processing. When a user performs print processing, the user opens a window related to printer setting, for example, to specify the settings of a printer and specify the settings of a printer driver regarding a method of print processing, e.g., print mode selection.

The printer 1500 includes a CPU 12, a ROM 13, an external memory 14, a system bus 15, a printing-unit interface 16, a printing unit 17, an input unit 18, a RAM 19, a memory controller (MC) 20, and an operation unit 1501. The printer 1500 is controlled by the CPU 12. The CPU 12 outputs image signals that are used to output print data to the printing unit 17, which is a printer engine and is connected to the system bus 15, according to a control program and the like stored in a program ROM in the ROM 13 or the external memory 14. The program ROM in the ROM 13 stores a control program and the like of the CPU 12. A font ROM in the ROM 13 stores font data and the like used in generating the output print data. A data ROM in the ROM 13 stores data and the like used in the host computer 3000 for a case where the printer 1500 does not include the external memory 14, for example, an HD.

The CPU 12 can establish communication with the host computer 3000 through the input unit 18 and can send data and the like in the printer 1500 to the host computer 3000. The RAM 19 serves as a main memory, a work area, and the like of the CPU 12, and the memory capacity of the RAM 19 can be expanded with an optional RAM (not shown) connected to an expansion port. The RAM 19 may serve as an output data loading area, an environmental data storage area, and a nonvolatile RAM (NVRAM). The MC 20 controls access to the external memory 14, for example, an HD and an integrated circuit (IC) card. The external memory 14 is connected to the printer 1500 as an optional component and stores font data, an emulation program, form data, and the like. The operation unit 1501 includes operation switches, a light emitting diode (LED) display, and the like.

The printer 1500 may include an NVRAM (not shown) that stores the setting data of printer mode input from the operation unit 1501.

In exemplary embodiments, the printing unit 17 includes an electrophotographic engine, and a content image and an associated copy-forgery-inhibited pattern image are printed with dots generated on the basis of print data of these images. Input data to the printing unit 17 is based on print data output from the host computer 3000 to the printer 1500. The CPU 12 rasterizes the input print data and outputs this rasterized image data to the printing unit 17 through the printing-unit interface 16. In the present invention, the printing system is not limited to such an electrophotographic system. The present invention can also be applied to any printer that employs a printing system that performs printing by generating dots, for example, an inkjet system or a known offset printing system.

In this embodiment, a copy-forgery-inhibited pattern image including a latent-image portion is generated by the host computer 3000, and the generated copy-forgery-inhibited pattern image is printed by the printing unit 17. However, the present invention is not limited to this embodiment, and a copy-forgery-inhibited pattern image may be generated within a printer. Moreover, in the present invention, a system that can generate a copy-forgery-inhibited pattern image only with a printer may be adopted instead of a system that includes a host computer and a printer.

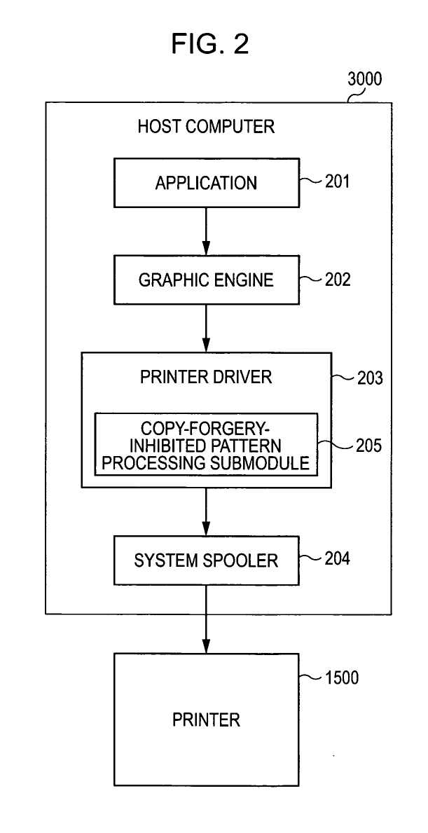

FIG. 2 shows an exemplary structure of the host computer 3000 for print processing shown in FIG. 1. The host computer 3000 includes program modules that are stored in the external memory 11 and that are loaded into the RAM 2 by an OS or by modules calling these modules and executed. The modules shown in FIG. 2 include an application 201, a graphic engine 202, a printer driver 203, and a system spooler 204. The application 201 and the printer driver 203 can be installed in an HD serving as the external memory 11 via an FD serving as the external memory 11, a compact disk-ROM (CD-ROM) (not shown), a network (not shown), or the like. The application 201, which is stored in the external memory 11, is loaded into the RAM 2 and executed. The application 201 executes printing (drawing) with the printer 1500 via the graphic engine 202, which is loaded into the RAM 2 and executed.

The graphic engine 202 loads the printer driver 203 into the RAM 2 from the external memory 11, the printer driver 203 being provided for a corresponding printing unit, for example, a printer, and adjusts the output from the application 201 for the printer driver 203. The graphic engine 202 converts graphic device interface (GDI) functions received from the application 201 to device driver interface (DDI) functions, and outputs these DDI functions to the printer driver 203. The printer driver 203 converts the DDI functions received from the graphic engine 202 to control commands that can be recognized by a printer, for example, commands written in a page description language (PDL). The converted printer control commands are output to the printer 1500 as print data via the system spooler 204, which is loaded into the RAM 2 by the OS, and the bidirectional interface 21.

The printing system according to this embodiment includes a copy-forgery-inhibited pattern processing submodule 205 in the printer driver 203. The copy-forgery-inhibited pattern processing submodule 205 may be a built-in module in the printer driver 203 or a library module that is separately installed. The printer driver 203 executes the copy-forgery-inhibited pattern processing submodule 205 to perform generation of a copy-forgery-inhibited pattern image, which is described below, and the like in relation to printing of a copy-forgery-inhibited pattern image.

Individual specifications and operations at the time of printing of the application 201, the graphic engine 202, the printer driver 203, and the system spooler 204 are the same as those that are generally known, and are thus not described further herein.

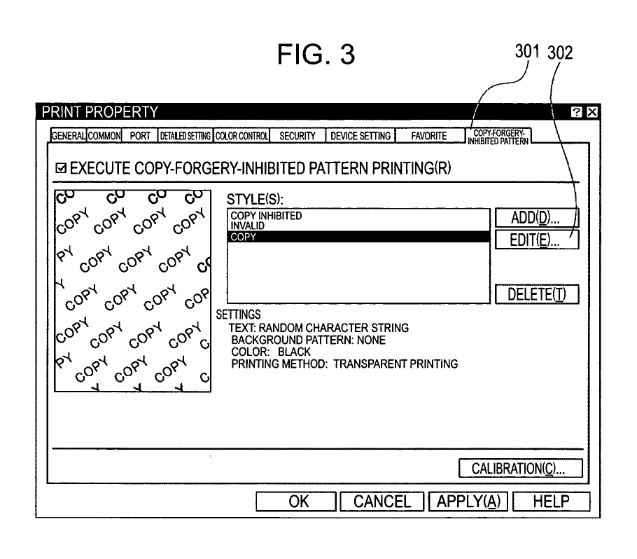

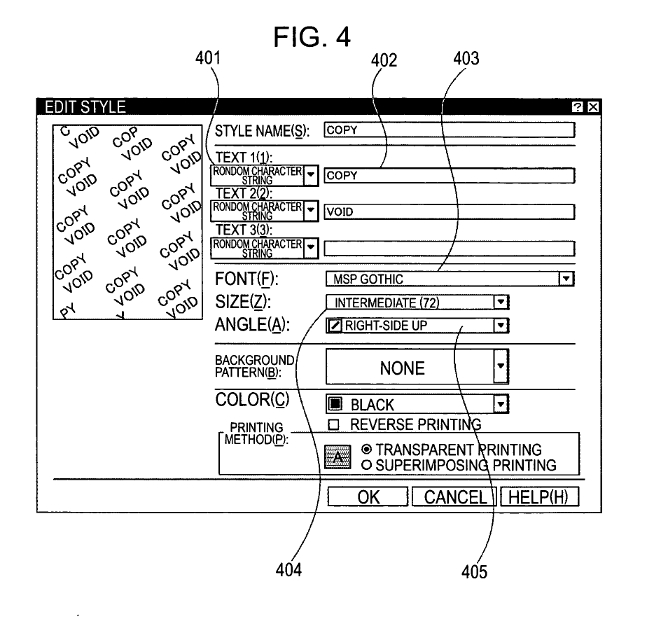

Next, the setting operation of copy-forgery-inhibited pattern printing will be described with reference to FIGS. 3 and 4.

FIGS. 3 and 4 show exemplary user interfaces for specifying the settings related to copy-forgery-inhibited pattern image generation.

FIG. 3 shows an exemplary initial screen of a user interface related to copy-forgery-inhibited pattern printing, the screen being provided in the printer driver 203. In this case, the settings related to copy-forgery-inhibited pattern printing can be specified on a property sheet 301 in a dialog box. Styles of a copy-forgery-inhibited pattern image can be selected on the property sheet 301. A user can edit the detailed settings of each style by pressing an edit button 302 in a state in which the style is selected.

FIG. 4 shows an exemplary edit screen of a copy-forgery-inhibited pattern style that is displayed by the user pressing the edit button 302 shown in FIG. 3.

In the exemplary screen shown in FIG. 4, three text strings to be latent copy-forgery-inhibited pattern images can be set. In the example shown in FIG. 4, the user can select the name of the host computer 3000, a user name registered in the host computer 3000, the IP (Internet Protocol) and physical address information of the host computer 3000, the name of a printing job, the job identification (ID), the date and time information, or the like by operating a corresponding text string type drop-down list 401.

When the user selects a random character string as a text string type (from the text string type drop-down list 401), the user can input a desired character string in a corresponding character-string input field 402.

A font can be selected as a style of the text strings. In a font-selection drop-down list 403, the user can select various types of fonts.

A font size can be selected as a style of the text strings. In a font-size-selection drop-down list 404, the user can select various sizes. Alternatively, the user can directly input any point size. A font size may be specified for each text string, or a common font size may be specified for all of the text strings.

An arrangement angle can be selected as a style of the text strings. In an angle-selection drop-down list 405, the user can select various arrangement angles. Alternatively, the user can directly input any angle.

Moreover, in the style edit screen, the color information of the copy-forgery-inhibited pattern image and background patterns on which the copy-forgery-inhibited pattern image is superimposed can be freely selected.

Other than the interface shown in FIG. 4, various types of interfaces for inputting a style may be used.

In FIG. 4, when the user sets the style of a copy-forgery-inhibited pattern, data of the style is registered in a copy-forgery-inhibited pattern image setting file (not shown). The copy-forgery-inhibited pattern image setting file is stored in the ROM 3.

Next, the controlling process for arranging predetermined latent character strings on the basis of the settings described above will be described, the controlling process constituting a part of a process of generating a copy-forgery-inhibited pattern image.

The arrangement of predetermined latent character strings suitable for a copy-forgery-inhibited pattern image will be described first.

In general, blocks, each including one or more predetermined latent character strings, are simply arranged to form a copy-forgery-inhibited pattern image. Even when a plurality of predetermined character strings form a latent image, these character strings are individually independent, and there is no special meaning in the order of the character strings. For example, when “COPY”, “USER NAME”, and “DATE” are respectively specified in “TEXT 1”, “TEXT 2”, and “TEXT 3” in FIG. 4, blocks are generated, in each of which predetermined latent character strings are arranged from the top to the bottom in order of “COPY”, “USER NAME”, and “DATE”. However, there is no special meaning in the order of this arrangement, and predetermined latent character strings may be arranged from the top to the bottom in order of “USER NAME”, “DATE”, and “COPY” without any problems. That is to say, even when the arrangement order of more than one predetermined latent character string is changed, this change does not substantially affect the copy-forgery-inhibited pattern image except in a particular case.

Thus, in this embodiment, lengths of individual predetermined character strings specified as components of the latent image are calculated, and a copy-forgery-inhibited pattern image, in which these predetermined character strings are most efficiently arranged, is generated by changing the arrangement order as required.

Specifically, the copy-forgery-inhibited pattern processing submodule 205 first calculates lengths of individual predetermined character strings at the time of drawing the predetermined character strings on the basis of the setting data, for example, characters, a font name, and a font size, of a copy-forgery-inhibited pattern image specified in the copy-forgery-inhibited pattern style edit screen shown in FIG. 4. After the lengths of the individual predetermined character strings are determined on the basis of the setting data, these predetermined character strings are sorted in order of length.

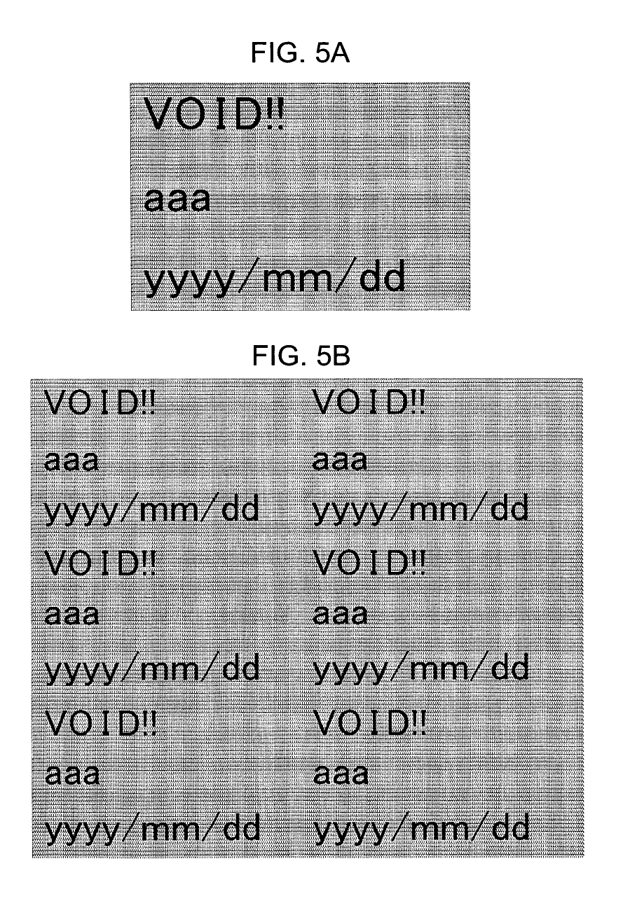

The sorting process described above will be described with reference to the drawings. FIG. 5A shows a copy-forgery-inhibited pattern image block in a case where a known arrangement process is performed. In this case, in the setting screen shown in FIG. 4, “RANDOM CHARACTER STRING” is specified in “TEXT 1” and a corresponding predetermined character string “VOID!!” is specified, “COMPUTER NAME” is specified in “TEXT 2” and a correspoding predetermined character string “aaa” that is the name of the host computer 3000 is specified, and “DATE” is specified in “TEXT 3” and a corresponding predetermined character string “yyyy/mm/dd” that is the date of printing is specified. In this case, “yyyy/mm/dd” is longest, “VOID!!” comes next, and “aaa” is shortest.

A copy-forgery-inhibited pattern image having a predetermined size is generated by repeatedly disposing this copy-forgery-inhibited pattern image block in a predetermined area. FIG. 5B shows this state.

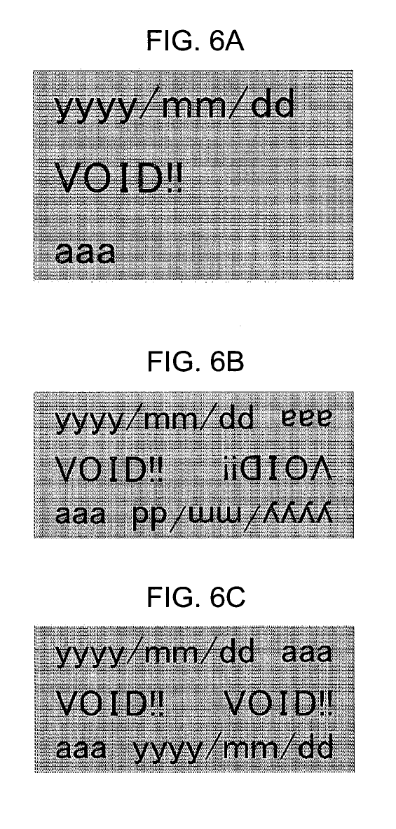

On the other hand, in this embodiment, three types of predetermined character strings shown in FIG. 5A are sorted in decreasing order of length, and the sorted predetermined character strings are combined with predetermined character strings obtained by rotating the sorted predetermined character strings by 180°. This arrangement is shown in FIGS. 6A, 6B, and 6C.

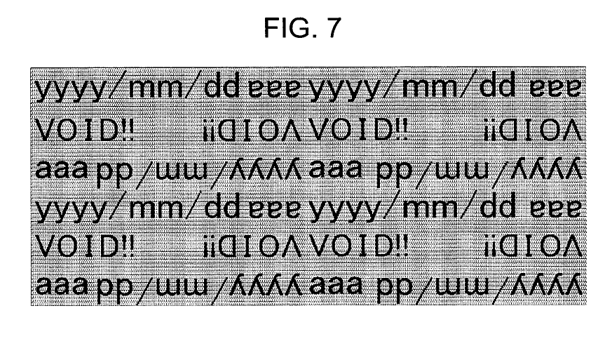

FIG. 6A shows a copy-forgery-inhibited pattern image block in which predetermined character strings are sorted. FIG. 6B shows a copy-forgery-inhibited pattern image block in which the predetermined character strings shown in FIG. 6A are combined with predetermined character strings obtained by rotating these predetermined character strings by 180°. FIG. 6C shows a copy-forgery-inhibited pattern image block in which the predetermined character strings shown in FIG. 6A are combined with predetermined character strings obtained by sorting these predetermined character strings in increasing order of length. Then, a copy-forgery-inhibited pattern image that includes few regions (unnecessary spaces) including no predetermined latent character strings can be generated by repeatedly disposing either the block shown in FIG. 6B or the block shown in FIG. 6C. FIG. 7 is an outline view of this copy-forgery-inhibited pattern image. This copy-forgery-inhibited pattern image is obtained by repeatedly disposing the copy-forgery-inhibited pattern image block shown in FIG. 6B. When FIG. 5B showing the arrangement of the predetermined latent character strings in a known copy-forgery-inhibited pattern image is compared with FIG. 7, it is apparent that fewer regions including no predetermined latent character strings occur in the copy-forgery-inhibited pattern image according to the present invention.

On a copy obtained by copying a printed document including a copy-forgery-inhibited pattern image, even when the predetermined latent character strings are flipped vertically as shown in FIGS. 6B and 7, no significant problem occurs so long as the predetermined latent character strings on the copy are reliably legible in one direction.

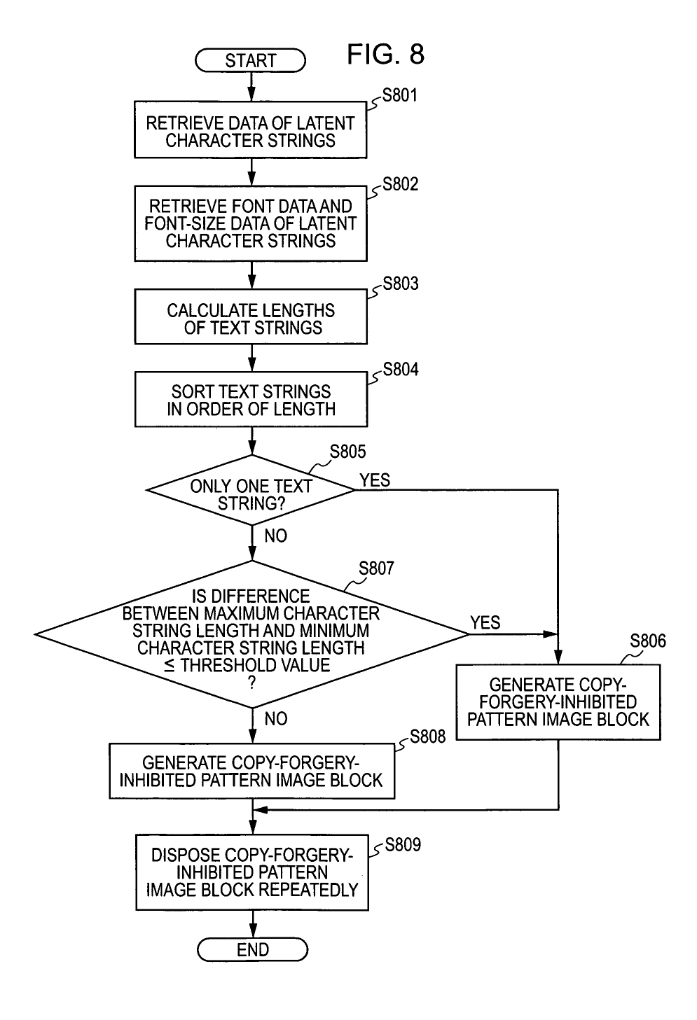

Next, the process for generating a copy-forgery-inhibited pattern image including the predetermined latent character strings described above will be described with reference to FIG. 8. The following process is performed by the CPU 1 executing the control program in the copy-forgery-inhibited pattern processing submodule 205.

When the process of copy-forgery-inhibited pattern printing is started, the copy-forgery-inhibited pattern processing submodule 205 shown in FIG. 2 retrieves the setting data registered in the copy-forgery-inhibited pattern image setting file (not shown). In this embodiment, first, a copy-forgery-inhibited pattern image block, for example, that shown in FIG. 6B, is generated, and the generated copy-forgery-inhibited pattern image block is repeatedly disposed as many times as required to cover a predetermined print size.

In step S801, data of predetermined latent character strings is retrieved from text data registered in the copy-forgery-inhibited pattern image setting file. In this case, when the user selects a random character string option and inputs a user-desired character string in the style edit screen shown in FIG. 4, the inputted character string is retrieved. When the user specifies the computer name, the date and time, or the like as a character string, the CPU 1 retrieves the specified data.

Then, in step S802, font data and font-size data of the predetermined latent character strings are retrieved from the copy-forgery-inhibited pattern image setting file.

In step S803, lengths of the individual text strings, in a case where the predetermined latent character strings retrieved in step S801 are actually drawn on the basis of the font data and font-size data retrieved in step S802, are calculated.

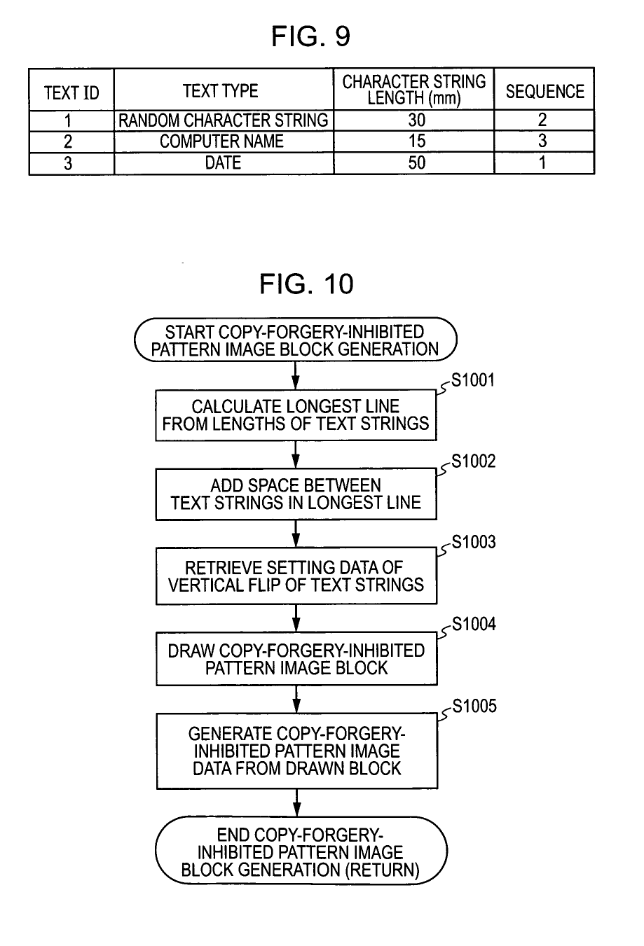

In step S804, the text strings are sorted in decreasing or increasing order of length on the basis of the lengths of the individual text strings calculated in step S803 to create a control table shown, such as the one in FIG. 9. Alternatively, the lengths of the individual text strings may be controlled without this control table in the process described here.

In the control table shown in FIG. 9, text IDs correspond to the respective three text string type drop-down lists 401 provided in the style edit screen shown in FIG. 4. The text types and the character string lengths calculated in step S803 are controlled in the control table so as to correspond to the respective text IDs. Then, sequential numbers from one to three are assigned to the text strings in decreasing order of length. Alternatively, the sequential numbers from one to three may be assigned to the text strings in increasing order of length. When a plurality of text strings having the same length exist, the sequential numbers may be assigned to the text strings in order of text ID.

Then, in step S805, it is determined whether the number of text strings is one. When the number of text strings is one, the process proceeds to step S806.

When the number of text strings is more than one, the process proceeds to step S807. In step S807, the difference between the length of the longest text string and that of the shortest text string is calculated and compared with a predetermined threshold value. When the difference is less than or equal to the predetermined threshold value, the process proceeds to step S806. When the difference is more than the predetermined threshold value, the process proceeds to step S808.

In step S808, a generating process of a copy-forgery-inhibited pattern image block, which will be described below in detail, is performed, and then the process proceeds to step S809.

In step S809, the copy-forgery-inhibited pattern image block generated in step S808 is repeatedly disposed on a predetermined area, for example, an entire printable area of a sheet. Then, the process for generating a copy-forgery-inhibited pattern image is completed.

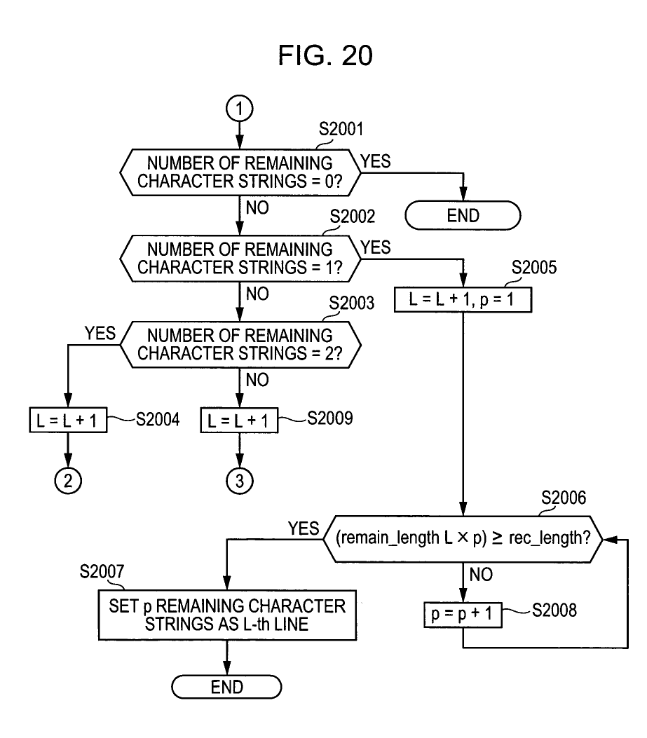

On the other hand, in step S806, the same process as a known generating process of a copy-forgery-inhibited pattern image block is performed, and the process proceeds to step S809. In a case where the number of the text strings as the predetermined latent character strings is one, when a copy-forgery-inhibited pattern image block including the text is generated in step S806 and repeatedly disposed in step S809, relatively few regions including no predetermined latent character strings are likely to occur. This also applies to a case where the number of text strings as the predetermined latent character strings is more than one and the difference between the lengths of the text strings are small. This case corresponds to the case shown in FIG. 17.

The predetermined threshold value used in step S807 may be preset in the control program as an initial value or may be freely specified by the user. For example, even in a case where there is no difference between the length of the longest text string and that of the shortest text string in a plurality of text strings, when the user needs to generate a copy-forgery-inhibited pattern image block (corresponding to one shown in FIG. 6B) including one set of the plurality of text strings and another set obtained by flipping the one set vertically or a copy-forgery-inhibited pattern image block (corresponding to one shown in FIG. 6C) including one set of the plurality of text strings and another set obtained by sorting the text strings in the one set in increasing or decreasing order of length, the user can specify zero as the predetermined threshold value.

Moreover, the determination process in step S807 may be skipped. In this case, for example, a check box including an option for performing an automatic arrangement of predetermined latent character strings may be provided in, for example, the style edit screen shown in FIG. 4, and the user may freely select this option.

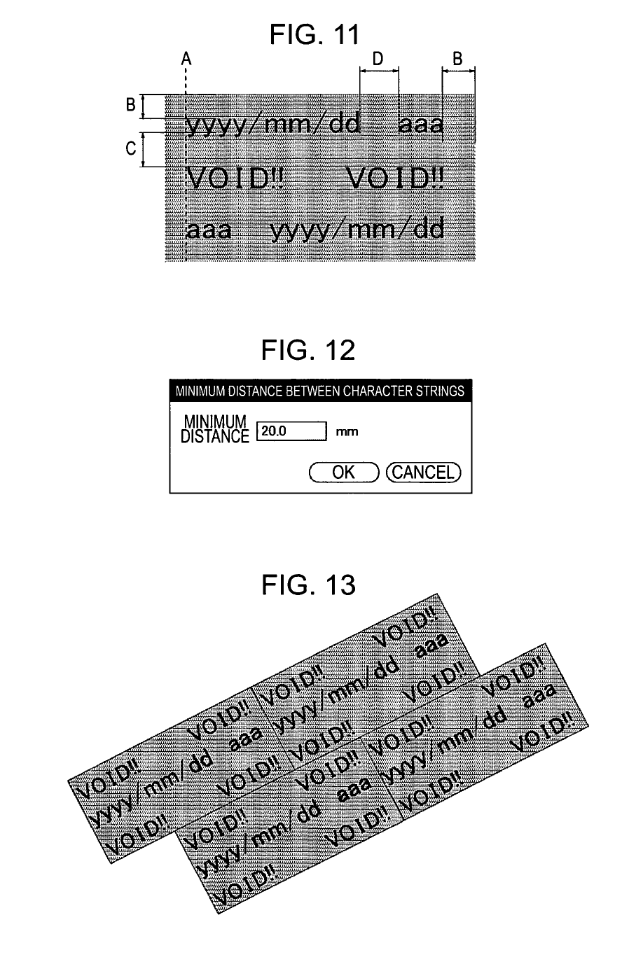

The generating process of a copy-forgery-inhibited pattern image block in step S808 in FIG. 8 is shown in detail in FIG. 10 and is described next.

FIG. 10 is a flowchart showing detailed steps in the generating process of a copy-forgery-inhibited pattern image block in step S808 (FIG. 8). The copy-forgery-inhibited pattern processing submodule 205 performs this process. Specifically, the CPU 1 executes the program of the generating process.

A copy-forgery-inhibited pattern image generating calculation and a drawing process described below in the generating process of a copy-forgery-inhibited pattern image block are described in detail in Japanese Patent Application No. 2003-324690 filed by the present inventor, and these calculation and drawing processes are used here. However, processes other than that described in this document may be adopted in the present invention.

In step S1001, the length of the longest line is calculated based on the lengths of the individual text strings calculated in step S803. Here, the longest line is a combined line, having the longest total length of combined character strings, among combined lines formed when first predetermined character strings arranged in increasing order of length are combined with second predetermined character strings obtained by sorting the first predetermined character strings in decreasing order of length in the horizontal direction. This will be described in detail with reference to the drawings.

In this embodiment, as shown in FIGS. 6B and 6C, a copy-forgery-inhibited pattern image block is formed by combining a first set of text strings arranged in decreasing order of length (shown in FIG. 6A) and a second set of text strings obtained by sorting the first set of text strings in increasing order of length. In FIGS. 6B and 6C, the longest text having a text ID of 3 (date) and the shortest text having a text ID of 2 (computer name) among the three text strings are combined to form one line.

In a case where there are three types of text strings having respective lengths L1, L2, and L3, where L1>L2>L3, total lengths of combined text strings in individual combined lines are L1+L3, L2+L2, and L3+L1. In this state, the total length L1+L3 is compared with the total length L2+L2, and the combined line having the longer total length is determined as the longest line.

In the case shown in FIG. 9, L1=50 mm (date), L2=30 mm (random character string), and L3=15 mm (computer name).

The total length L1+L3 is 65 mm, and the total length L2+L2 is 60 mm. Thus, in this case, the combined line having the total length L1+L3 is the longest line.

In the case described above, the total length of the longest and shortest character strings combined with each other in a line is compared with the total length of the same character strings, other than the longest and shortest character strings, combined with each other in a line, and the line having a longer total character string length is defined as the longest line. That is to say, although the total length L1+L2 (80 mm) is larger than the total length L1+L3 (65 mm), the total length L1+L2 is not the total length of the longest and shortest character strings. Thus, a line having the total length L1+L2 is not considered to be the longest line.

Then, in step S1002, a space is added between the text strings in the longest line to improve the visibility when the text strings appear clearly on a copy.

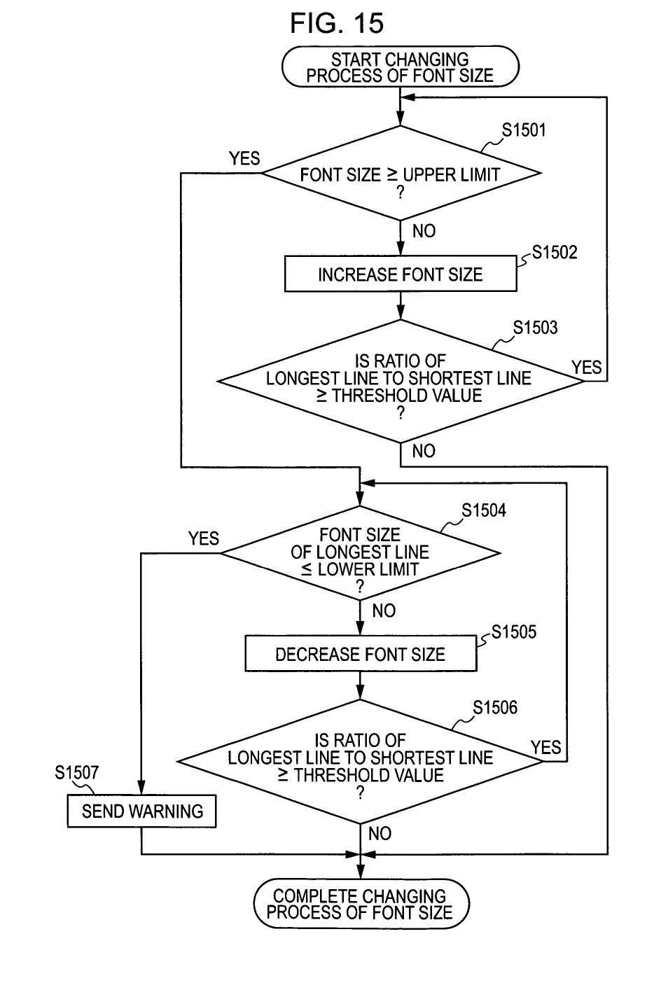

The space may be specified by the user as required in, for example, a setting screen shown in FIG. 12, or may be preset in the control program. For example, in FIG. 12, the space is specified by the user as 20 mm. In this case, the horizontal length of a copy-forgery-inhibited pattern image block is 85 mm obtained by adding 20 mm to 65 mm that is the total length of the text strings having a text ID of 3 (date) and the text having a text ID of 2 (computer name).

Margins may be suitably set around the combined lines to prevent character strings in a copy-forgery-inhibited pattern image block being too close to those in adjacent copy-forgery-inhibited pattern image blocks to improve the visibility. Thus, the vertical length of a copy-forgery-inhibited pattern image block may be obtained by adding lengths of margins to the right and left of a combined line to 85 mm.

Then, in step S1003, the setting data of vertical flip of text strings is retrieved. The settings of vertical flip of text strings are specified so as to select a copy-forgery-inhibited pattern image shown in FIG. 6B or a copy-forgery-inhibited pattern image shown in FIG. 6C. These settings may be preset in the control program or may be specified in the style edit screen shown in FIG. 4.

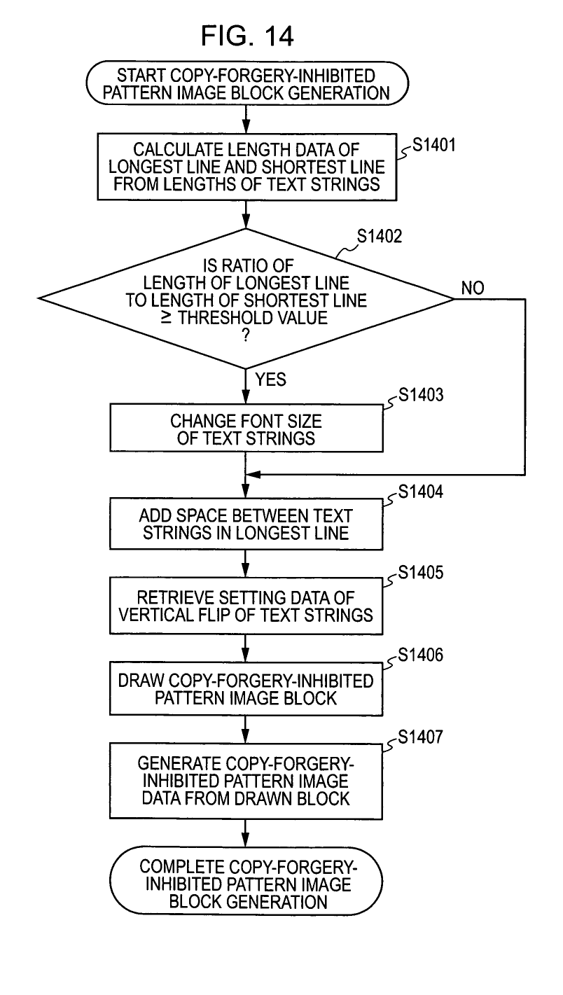

In step S1004, the text strings are drawn according to the length calculated in steps S1001 and S1002 and the settings of vertical flip of text strings retrieved in step S1003. FIG. 11 shows an exemplary drawn image when the settings of vertical flip of text strings are specified so that vertical flip of text strings is not performed. FIG. 11 includes markings to indicate a drawing reference position A, a block margin B, a line space C, and a space between text strings D.

The predetermined character strings in the first line are first drawn according to various types of setting data calculated in steps S1001 and S1002. In the case of FIG. 6C, the predetermined character strings in the first line are the character string having a text ID of 3 (date) and the character string having a text ID of 2 (computer name). Block margins are set above, to the left of, and to the right of the first line, and then the first line is drawn with consideration of a drawing reference position and a space between the text strings.

Then, the second line including the two random character strings “VOID!!” is drawn. When the second line is drawn, a predetermined line space is set between the first and second lines, and the first character string in the second line is positioned at a drawing reference position. The line space may be preset in the control program or may be freely specified by the user.

Since the total length of the character strings in the second line is smaller than the total length of the character strings in the first line, a space between the text strings in the second line is set so that the length of the second line is substantially the same as that of the first line.

Then, the third line is drawn in the same manner as the first line (except with the order of the text strings switched) with a predetermined line space provided between the second and third lines.

The same process is repeated as many times as the number of text strings set in the style edit screen. The size of a copy-forgery-inhibited pattern image block may be determined on the basis of the number of text strings, a font size, various types of margin data, and the like before text strings are drawn, and individual lines may be drawn in the copy-forgery-inhibited pattern image block.

Although the drawing process of character strings is started from the first line, the sequence is not limited to this case in the present invention.

Moreover, the drawing reference positions are not necessarily located on a vertical line. Alternatively, the drawing reference positions may be located on a line inclined at a predetermined angle.

When the drawing of a copy-forgery-inhibited pattern image block is completed in step S1004, the process moves to step S1005 where copy-forgery-inhibited pattern image data is generated based on the copy-forgery-inhibited pattern image block data. There are various types of methods for generating a copy-forgery-inhibited pattern image from a drawn copy-forgery-inhibited pattern image block. Any of these methods may be adopted in the present invention. In this embodiment, a copy-forgery-inhibited pattern image is generated by a logical operation disclosed in Japanese Patent Application No. 2003-324690. The logical operation is performed based on drawing data, a dot pattern for a latent-image portion, and a dot pattern for a background-image portion.

When the steps described above are completed, copy-forgery-inhibited pattern image block generation is completed, and the process proceeds to step S809 in FIG. 8 (described above).

When the process in step S809 in FIG. 8 is completed, a copy-forgery-inhibited pattern image shown in FIG. 7 is finally generated.

In this embodiment, a copy-forgery-inhibited pattern image block is first generated, and a copy-forgery-inhibited pattern image is generated by repeatedly disposing the copy-forgery-inhibited pattern image block like tiles. Alternatively, a copy-forgery-inhibited pattern image may be generated by disposing drawn data of individual character strings like tiles.

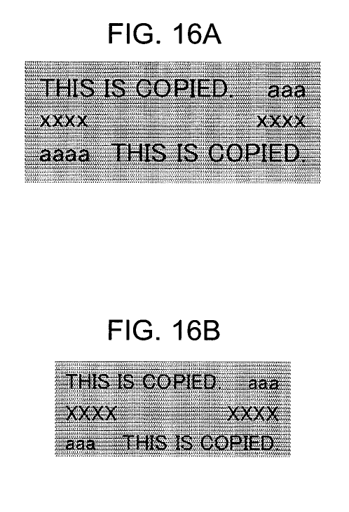

Moreover, as shown in FIG. 13, the longest line may be the second line in a copy-forgery-inhibited pattern image block. Alternatively, the longest line may be freely specified by the user depending, for example, the importance of each character string, or may be determined by a control unit depending on a combination of text strings. The copy-forgery-inhibited pattern processing submodule 205 can perform the copy-forgery-inhibited pattern image block drawing in step S1004 in FIG. 10 based on these settings.

When a copy-forgery-inhibited pattern image includes a plurality of predetermined character strings, a copy-forgery-inhibited pattern image in which the predetermined character strings are efficiently arranged can be readily generated by employing the arrangement and process described above.

### Second Embodiment

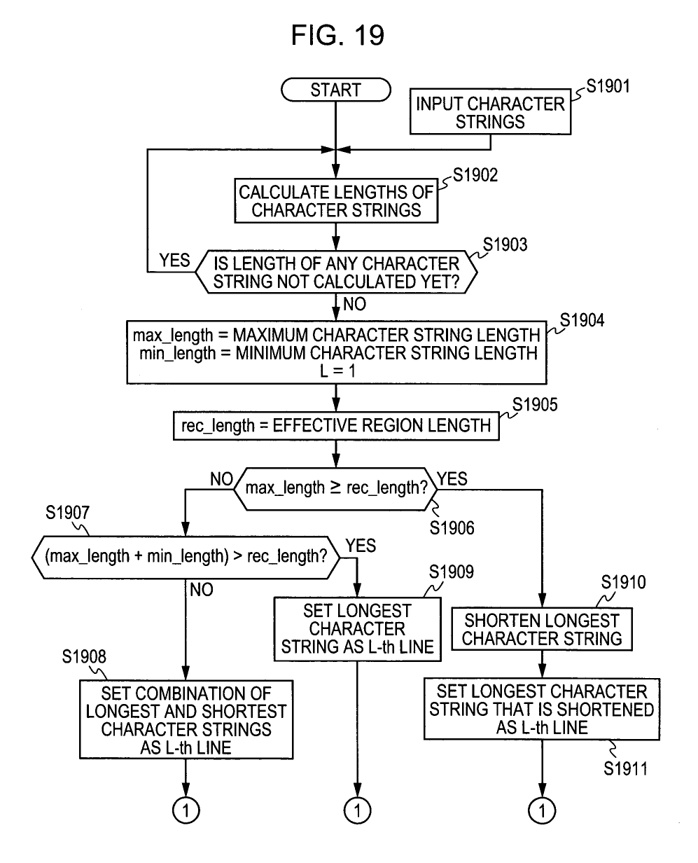

Unnecessary space in a copy-forgery-inhibited pattern image can be sufficiently reduced by adopting the method described in the first embodiment. However, as shown in FIG. 16A, in a case where there is much difference between lengths of individual predetermined character strings, unnecessary space may be increased.

In this embodiment, even when there is much difference between lengths of individual predetermined character strings, a copy-forgery-inhibited pattern image in which the predetermined character strings are efficiently arranged can be generated. Steps in the second embodiment other than steps for generating a copy-forgery-inhibited pattern image are the same as those in the first embodiment. Thus, the description of these steps is not repeated here.

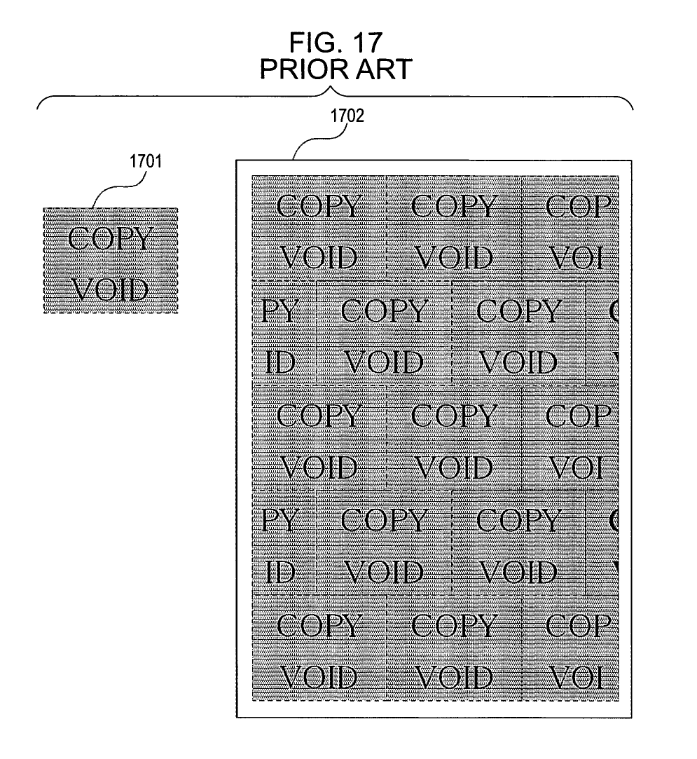

FIG. 14 is a flowchart showing the process flow in this embodiment corresponding to the copy-forgery-inhibited pattern image block drawing process in step S808 in FIG. 8.

In step S1401, the length of the longest line is calculated as in step S1001 in FIG. 10, and the length of the shortest line is additionally calculated.

In step S1402, the ratio of the length of the longest line to the length of the shortest line is calculated, and the calculated value is compared with a predetermined threshold value. Although any method can be adopted to calculate the ratio, in this embodiment, the length of the longest line measured in millimeters is divided by the length of the shortest line measured in millimeters, and the calculated value is compared with the predetermined threshold value.

When the calculated ratio is less than the predetermined threshold value, it is determined that few unnecessary gaps occur in a copy-forgery-inhibited pattern image generated on the basis of these lengths, and the process proceeds to step S1404. Then, the same process as that in FIG. 10 in the first embodiment is performed.

When it is determined in step S1402 that the calculated ratio is equal to or greater than the predetermined threshold value, it is determined that unnecessary gaps occur in a copy-forgery-inhibited pattern image, and the process proceeds to step S1403.

In step S1403, font sizes of text strings are changed so that the ratio of the length of the longest line to the length of the shortest line becomes less than the predetermined threshold value.

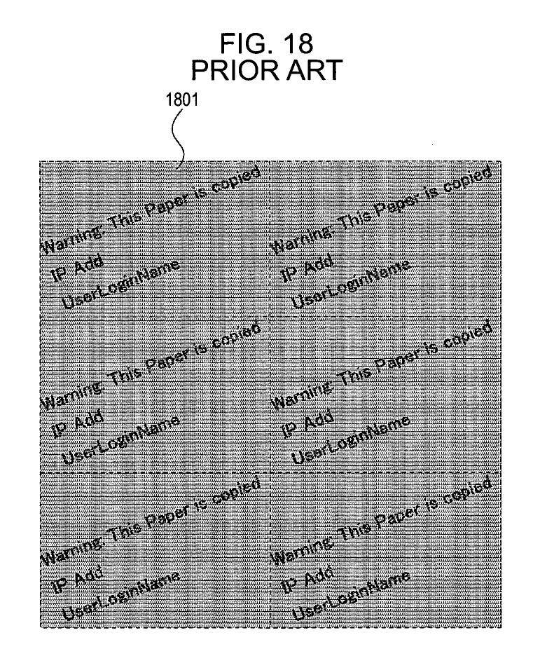

The process for changing font sizes of text strings will be described in detail with reference to FIG. 15.

In this process flow in FIG. 15, font sizes of individual text strings that constitute the longest and shortest lines and other lines are changed. In this process, when font sizes are carelessly changed, the balance between text strings embedded in a copy-forgery-inhibited pattern image may be lost, and the copy-forgery-inhibited pattern image may not work as required. In particular, a copy-forgery-inhibited pattern image is generated on the basis of small and large dot patterns. Thus, when font sizes are less than a predetermined size, the legibility of a latent image on a copy may be impaired. In this case, font sizes should be changed so as to keep the legibility. Accordingly, font sizes are changed in stages based on a predetermined ratio so as to keep the legibility of a copy-forgery-inhibited pattern image and the balance between character strings.

In step S1501, it is determined whether a font size of text strings that constitute the shortest line is less than a predetermined upper limit.

When the font size is less than the predetermined upper limit, the process proceeds to step S1502 where the font size of the text strings, which constitute the shortest line, is increased in a predetermined range.

The upper limit is a font size that does not impair the balance of a copy-forgery-inhibited pattern image. For example, when the current font size of the text strings, which constitute the shortest line, is 45, the upper limit is set to 60, and the font size of the text strings is increased in units of 5. With this arrangement, the balance of character strings is not carelessly lost, and the font size can be substantially adjusted to a user-desired size. The upper limit may be set to a size about one and a half times as large as the current font size, or may be predetermined regardless of the current font size.

In step S1503, the length of the shortest line is recalculated on the basis of the changed font size, and the ratio of the length of the longest line to the recalculated length of the shortest line is compared with a predetermined threshold value.

When the ratio is less than the predetermined threshold value, it is determined that copy-forgery-inhibited pattern character strings can be efficiently arranged by the font size change, and the changing process of font size is completed.

On the other hand, when the ratio is equal to or greater than the predetermined threshold value, the process returns to step S1501, and the process described above is repeated.

When it is determined in step S1501 that the font size of the shortest line is equal to or greater than the upper limit, the process proceeds to step S1504.

In this case, the font size of the shortest line cannot be changed. Thus, a font size of the longest line is changed.

In step S1504, it is determined whether the font size of the longest line is less than or equal to a predetermined lower limit. The predetermined lower limit is a font size that does not impair the legibility on a copy.

When it is determined in step S1504 that the font size is not less than or equal to the predetermined lower limit, the font size of the longest line is decreased in a predetermined range in step S1505.

Then, in step S1506, the length of the longest line is recalculated on the basis of the changed font size, and the ratio of the recalculated length of the longest line to the length of the shortest line is compared with a predetermined threshold value.

When the ratio is less than the predetermined threshold value, it is determined that copy-forgery-inhibited pattern character strings can be efficiently arranged by the font size change, and the changing process of font size is completed.

On the other hand, when the ratio is greater than or equal to the predetermined threshold value, the process returns to step S1504, and the process described above is repeated.

In a case where it is determined in step S1504 that the font size of the longest line is less than or equal to the predetermined lower limit or less, even when the font sizes of the longest and shortest lines are changed, the character strings cannot be arranged efficiently. Thus, a warning message is sent to the user (step S1507). The warning message indicates that the ratio of the amount of space including no character strings to the entire copy-forgery-inhibited pattern image is equal to or greater than a predetermined ratio. Then, the process is completed.

The user can change the style in the style edit screen of a copy-forgery-inhibited pattern image in response to the warning message. The process for generating a copy-forgery-inhibited pattern image may be continued.

FIG. 16A shows a copy-forgery-inhibited pattern image block in which font sizes of character strings are not changed, and FIG. 16B shows a copy-forgery-inhibited pattern image block in which font sizes of character strings are changed as shown in FIG. 15 and described above.

In FIG. 16A, a large space occurs between text strings “XXXX” in the second line. In contrast, in FIG. 16B, the space between the text strings in the second line is reduced by decreasing a font size of text strings “THIS IS COPIED.” and “aaa” in the first and third lines and increasing a font size of the text strings “XXXX” in the second line.

Moreover, since the font size of the text strings in the longest line is reduced, the size of the copy-forgery-inhibited pattern image block shown in FIG. 16B is smaller than the size of the copy-forgery-inhibited pattern image block shown in FIG. 16A. In a copy-forgery-inhibited pattern image, these blocks are arranged like tiles. Thus, when the block size is smaller, more blocks can be disposed in an area having a predetermined size, for example, a printable area of a print sheet, and a copy-forgery-inhibited pattern image in which the amount of unnecessary space is negligible can be generated.

As described above, according to this embodiment, a copy-forgery-inhibited pattern image in which the amount of unnecessary space is negligible can be generated efficiently even when there is a significant difference between lengths of character strings.

In the process flow in this embodiment, it is assumed that a common font size is used for a plurality of text strings for the sake of simplifying the illustration. However, in some cases, different font sizes are used for the plurality of text strings. In these cases, the largest font size of text in the shortest line is suitably compared with the upper limit, and the smallest font size of text in the longest line is suitably compared with the lower limit.

Other than the font size change, printing character strings in boldface can also reduce the amount of unnecessary space. Moreover, the amount of unnecessary space can also be reduced by increasing or decreasing distances between characters. Moreover, a copy-forgery-inhibited pattern image can be generated more effectively using the methods described above in combination.

### Third Embodiment

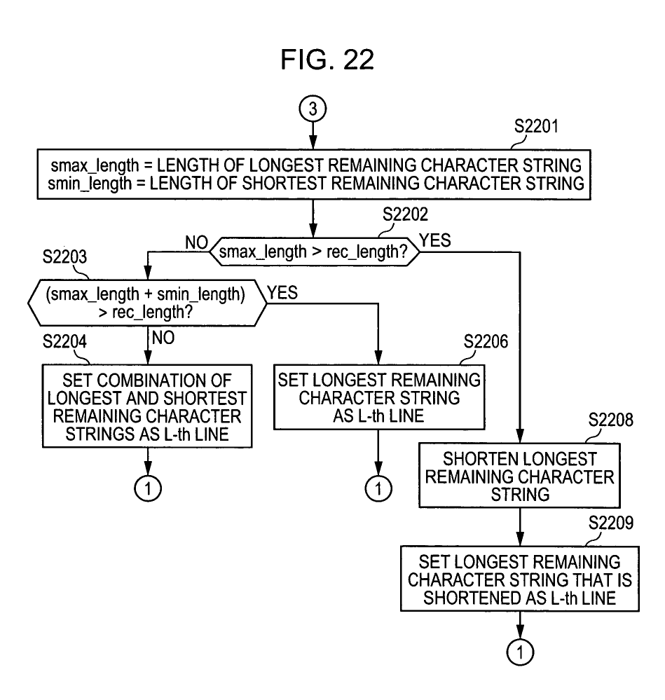

In the embodiments described above, a user inputs a plurality of types of character strings for generating patterns including the plurality of types of character strings, the arrangement order of the input character strings is changed and/or the input character strings are duplicated, and combinations (hereinafter called combination sets) of these character strings are determined so that few gaps occur. A third embodiment according to the present invention is described next with reference to flowcharts of FIGS. 19 to 22. The process described in these flowcharts is performed by the CPU 1 executing the control program in the copy-forgery-inhibited pattern processing submodule 205.

In step S1901 (of FIG. 19), a user inputs a user-desired character string in the character-string input field 402 in the user interface shown in FIG. 4. The user can input more than one type of character string. In the character-string input field 402 shown in FIG. 4, three types of character strings can be input. Alternatively, more than three types of character strings, for example, four, five, or six types, may be input.

In step S1902, lengths of the character strings input in step S1901 are calculated. Each of the input character strings may include a plurality of characters or a single character.

For example, when a fixed-width font for horizontal writing is used, the length of each character string is calculated by multiplying a character size in the horizontal direction by the number of characters. When a variable-width font (a proportional font) for horizontal writing is used, the length of each character string is calculated based on of the total size of each character string in the horizontal direction. The length of each character string can be accurately calculated with consideration of character spacing, inter-character space, and the like for character arrangement. Character spacing represents space between two adjacent characters, and inter-character space represents distance between reference positions of two adjacent characters. Regarding the length of a character string, this description also applies to the first and second embodiments.

In step S1903, it is determined whether the length of any of the character strings input in S1901 is not calculated yet. When the length of any character string is not calculated yet, the process returns to step S1902 and steps S1902 and S1903 are repeated until it is determined in step S1903 that the lengths of all character strings input in step S1901 have been calculated. When lengths of all of the character strings are calculated, the process proceeds to step S1904. Even while any of step S1904 and the following steps is being performed, step S1903 is performed every time a character string is input in step S1901, so that the process returns to step S1902 where the length of the input character string is calculated.

In step S1904, the maximum and minimum character string lengths calculated in step S1902 and “1” are stored in parameters max_length, min_length, and L, respectively. Character strings, lengths of which are stored in max_length and min_length, are also stored corresponding to these two parameters.

In step S1905, an effective region length is stored in rec_length (“rec” is an abbreviation of “rectangle”). An effective region length is based on, for example, the length of the block image shown in FIGS. 6A, 6B, or 6C in the horizontal direction for horizontal writing or the length of the block image in the vertical direction for vertical writing. The base of an effective region length is not limited to the block image. Alternatively, an effective region length may be a length of a printable area of a print sheet in the horizontal or vertical direction.

An effective region length is a reference length for determining whether a single character string, a plurality of types of character strings, or a plurality of character strings of one type are disposed in a line.

In step S1906, it is determined whether the value of max_length is equal to or greater than the value of rec_length.

When it is determined in step S1906 that max_length is less than rec_length, it is determined whether the total of the value of max_length and the value of min_length is more than the value of rec_length in step S1907. The result of this determination is used to determine whether the longest and shortest character strings can be disposed in an area having the length represented by rec_length.

When it is determined in step S1907 that max_length+min_length is not greater than rec_length, the longest and shortest character strings are set as character strings in the L-th line in step S1908. That is to say, a plurality of character strings are selected from the plurality of types of character strings input in step S1901 so that the total length of the selected character strings is close to the reference length. Then, the selected character strings are disposed, and the process proceeds to steps in FIG. 20.

On the other hand, if it is determined in step S1907 that max_length+min_length is greater than rec_length, the longest character string is set as the L-th line in step S1909. That is to say, a single character string is selected from the plurality of types of character strings input in step S1901 so that the total length of the selected character string is close to the reference length. Then, the selected character string is disposed. At this point after the process in step S1904, the L-th line is the first line. The process then proceeds to steps in FIG. 20.

When it is determined in step S1906 that max_length is equal to or greater than rec_length, the longest character string is shortened in step S1910 so that the longest character string is disposed in an area having the effective region length (rec_length). For example, the longest character string is shortened by decreasing the font size of the longest character string. When it is determined that the value of max_length is equal to the value of rec_length in step S1906, the longest character string is shortened by a factor of 1.0 in step S1910. Then, in step S1911, the longest character string, which is shortened in step S1910, is set as a character string in the L-th line. That is to say, a single character string is selected from the plurality of types of character strings input in step S1901 so that the total length of the selected character string is close to the reference length. Then, the selected character string is disposed. The process then proceeds to steps in FIG. 20.

Next, FIG. 20 will be described. Steps in FIG. 20 are performed after steps S1908, S1909, and S1911 in FIG. 19. In the steps in FIG. 20, after a single character string or a plurality of character strings in the first line are selected, character strings in the next line are selected.

In step S2001, it is determined whether the number of remaining types of character strings other than the character strings selected as character strings in any of the first to L-th lines among the character strings input in step S1901 is zero. When the number of remaining types of character strings is zero, the process is completed. On the other hand, when the number of remaining types of character strings is not zero, it is determined whether the number of remaining types of character strings is one in step S2002.

When it is determined in step S2002 that the number of remaining character strings is one, “1” is added to the value of the parameter L and “1” is stored in a parameter p in step S2005.

Then, in step S2006, it is determined whether a value obtained by multiplying the value of remain_length by the value of p is greater than or equal to the value of rec_length. The parameter remain_length represents the length of the remaining character string. In step S2006, the number of copies of the remaining type of character string to be disposed in a line is determined. That is to say, copies of a character string other than the character strings selected in steps S1908, S1909, and S1911 are disposed so that the total length of the copies of the character string is close to the reference length.

When it is determined in step S2006 that the remaining_length L*p is greater than or equal to rec_length, p copies of the only remaining type of character string determined in step S2002 are set as the L-th line in step S2007. On the other hand, when it is determined in step S2006 that the remaining_length L*p is less than rec_length, “1” is added to the value of p in step S2008 and the process in step S2006 is repeated until it is determined in step S2006 that it is determined in step S2006 that the remaining_length L*p is greater than or equal to rec_length.

When it is determined in step S2002 that the number of remaining character strings is not one (i.e., there are more than one remaining character strings), it is determined in step S2003 whether the number of remaining types of character strings is two. When it is determined in step S2003 that the number of remaining character strings is two, “1” is added to the value of L in step S2004 and the process proceeds to steps in the flowchart of FIG. 21.

On the other hand, when it is determined in step S2003 that the number of remaining character strings is not two (i.e., there are three or more remaining character strings), “1” is added to the value of L in step S2009 and the process proceeds to steps in the flowchart of FIG. 22.

Next, the flowchart of FIG. 21 will be described. Steps in the flowchart of FIG. 21 are performed after step S2004 in the flowchart of FIG. 20. In the steps in the flowchart of FIG. 21, arrangement of the two remaining types of character strings is determined.

In step S2101, it is determined whether the total length of the two remaining types of character strings is greater than the effective region length (rec_length). If so, the process proceeds to step S2102. Otherwise, the process proceeds to step S2110.

In step S2102, the longer character string is set as the L-th line. Then, in step S2103, “2” is stored in a parameter r.

Then, in step S2104, it is determined whether a value obtained by multiplying the length of the shorter character string by the value of r is more than the value of rec_length. If so, the result in step S2102 is cancelled and the two remaining character strings, which are shortened, are set as character strings to be disposed in the L-th line in step S2105. That is to say, a plurality of character strings other than the character strings selected in steps S1908, S1909, and S1911 are disposed so that the total length of the plurality of character strings is close to the reference length.

On the other hand, when it is determined in step S2104 that the length of the shorter character string multiplied by r is less than or equal to rec_length, “1” is added to the value of L in step S2106, and it is determined whether the value obtained by multiplying the length of the shorter character string by the value of r is more than the value of rec_length in step S2107.

When it is determined in step S2107 is that the length of the shorter character string multiplied by r is greater than rec_length, r copies of the shorter character string are set as character strings in the L-th line in step S2108. That is to say, copies of a character string other than the character strings selected in steps S1908, S1909, and S1911 are disposed so that the total length of the copies of the character string is close to the reference length.

On the other hand, when it is determined in step S2107 is that the length of the shorter character string multiplied by r is less than or equal to rec_length, “1” is added to the value of r in step S2109 and the process in step S2107 is repeated until it is determined in step S2107 that the length of the shorter character string multiplied by r is greater than rec_length.

When it is determined in step S2101 that the total length of the two remaining character strings is not greater than rec_length, the process proceeds to step S2110 where “1” is stored in a parameter q.

Then, in step S2111, it is determined whether the total length of the longer character string and q copies of the shorter character string is greater than or equal to the value of rec_length.

When it is determined in step S2111 that the total length of the longer character string and q copies of the shorter character string is greater than or equal to the value of rec_length, the longer character string and q copies of the shorter character string are set as the L-th line in step S2112. That is to say, a plurality of character strings other than the character strings selected in steps S1908, S1909, and S1911 are disposed so that the total length of the plurality of character strings is close to the reference length. On the other hand, when the total length of the longer character string and q copies of the shorter character string is less than the value of rec_length, “1” is added to the value of q in step S2113 and the process in step S2111 is repeated until it is determined in step S2111 that the total length of the longer character string and q copies of the shorter character string is greater than or equal to the value of rec length.

Next, the flowchart of FIG. 22 will be described. Steps in the flowchart of FIG. 22 are performed after step S2009 in the flowchart of FIG. 20. In the steps in the flowchart of FIG. 22, arrangement of more than two character strings is determined.

In step S2201, the length of the longest remaining character string and the length of the shortest remaining character string are stored in parameters smax_length and smin_length, respectively.

The longest remaining character string is the longest character string among the remaining character strings, arrangement of which in a line is not determined yet, and the shortest remaining character string is the shortest character string among the remaining character strings.

In step S2202, it is determined whether the value of smax_length is greater than the value of rec_length. If not, the process proceeds to step S2203.

In step S2203, it is determined whether the total of the value of smax_length and the value of smin_length is more than the value of rec_length. If it is determined in step S2203 that the total of the value of smax_length and the value of smin_length is less than or equal to the value of rec_length, the longest and shortest remaining character strings are set as the L-th line in step S2204, and the process returns to the steps in the flowchart of FIG. 20. That is to say, a plurality of character strings other than the character strings selected in steps S1908, S1909, and S1911 are disposed so that the total length of the plurality of character strings is close to the reference length.

On the other hand, if it is determined in step S2203 that the total of the value of smax_length and the value of smin_length is more than the value of rec_length, the longest remaining character string is set as the L-th line in step S2206. That is to say, a character string other than the character strings selected in steps S1908, S1909, and S1911 is disposed so that the total length of the character string is close to the reference length, and the process returns to the steps in the flowchart of FIG. 20.

When it is determined in step S2202 that smax_length is greater than rec_length, the process proceeds to step S2208.

In step S2208, the longest remaining character string is shortened. The_shortening process in step S2208 is the same as that in step S1910. Then, in step S2209, the longest remaining character string, which is shortened, is set as a character string in the L-th line. That is to say, a character string other than the character strings selected in steps S1908, S1909, and S1911 is disposed so that the total length of the character string is close to the reference length. Then, the process returns to the steps in the flowchart of FIG. 20, and the steps described in FIG. 20 are repeated.

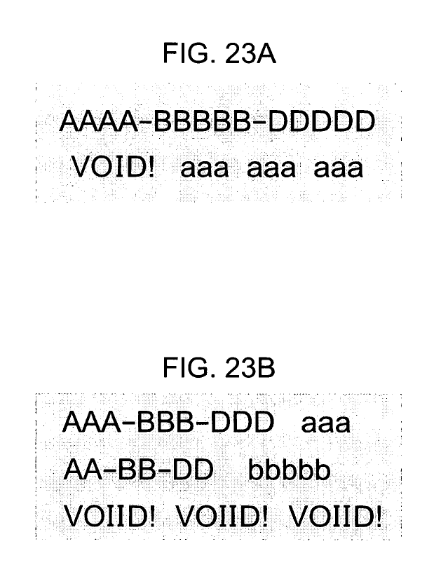

FIGS. 23A and 23B show exemplary character patterns generated in the process described in the flowcharts of FIGS. 19 to 22.

FIG. 23A shows a pattern generated when the determination result in step S1906 is YES, the determination result in step S2003 is YES, the determination result in step S2101 is NO, and the determination result is NO for the first and second determinations in step S2111 and YES for the third determination in step S2111.

FIG. 23B shows a pattern generated when the determination result in steps S1906 and S1907 are NO. Then, the determination result in step S2003 in the flowchart of FIG. 20 is NO, and the process proceeds to the steps in the flowchart of FIG. 22. In the flowchart of FIG. 22, the determination results in steps S2202 and S2203 are NO. Then, the process returns to the steps in the flowchart of FIG. 20, and the determination result in S2002 is YES because the only remaining character string is “VOIID!”. Then, the process in step S2007 is performed after steps S2006 and S2008 to generate the pattern shown in FIG. 23B.

Then, the generated character pattern (combination set) as shown in FIG. 23A or 23B is repeatedly disposed as in the processes in step S808 in FIG. 8 and step S1005 in FIG. 10 to generate the pattern as shown in FIG. 13. The generated patterns are used by a printer driver of a data-processing apparatus as background patterns, copy-forgery-inhibited pattern images, and the like, and are sent to a printer as a part of print data and printed by the printer.

As described above, according to the third embodiment, character-string patterns having a high visibility can be generated. Especially when the third embodiment is applied to copy-forgery-inhibited patterns, the visibility of latent character strings on a copy is improved.

### Fourth Embodiment

In the third embodiment, character strings are disposed in an image block. Alternatively, character strings may be disposed in a certain effective region instead of an image block. The certain effective region may be an effective region of a sheet of a predetermined size.

When character strings are disposed in the certain effective region, a single character string or a plurality of character strings are input through the user interface shown in FIG. 4, and the single character string or the plurality of character strings are repeatedly disposed at as many as possible predetermined intervals. For example, when the input character strings are “AA”, “BBB”, and “CCCC”, these character strings are repeatedly disposed as much as possible in a line in this order. When the character strings cannot be disposed in a line, the character strings are repeatedly disposed in the next line. When this process is performed for all lines in the effective region, the visibility of the character strings is improved. The visibility of latent character strings on a copy is improved, especially when this process is applied to copy-forgery-inhibited pattern images.

### Other Embodiments

The present invention may be applied to a system including a plurality of units, for example, a host computer, an interface unit, a reader, and a printer, or may be applied to a device, for example, a copying machine, a printer, or a facsimile machine, including a single unit.

The present invention is also implemented by providing, to a system or a device, a recording medium storing program code that performs the functions according to the embodiments described corresponding to the processes in the flowcharts in the drawings and by causing a computer (a CPU or an micro-processing unit (MPU)) included in the system or in the device to read out and execute the program code stored in the recording medium.

In this case, the program code read from the recording medium performs the functions according to the embodiments described above.

Typical recording media for providing the program code includes floppy disks, hard disks, optical disks, magneto-optical (MO) disks, compact disk-ROMs (CD-ROMs), CD-recordables (CD-Rs), magnetic tapes, nonvolatile memory cards, or ROMs.

Moreover, other than the case where the program code is read out and executed by a computer to perform the functions according to the embodiments described above, the present invention also includes a case where, for example, an operating system (OS) operating on a computer executes some or all of the actual processing to perform the functions according to the embodiments described above, based on instructions from the program code.

Moreover, the present invention also includes a case where the program code read out from the recording medium is written to a memory included in, for example, a function expansion board inserted in a computer or a function expansion unit connected to a computer, and then, for example, a CPU included in the function expansion board, the function expansion unit, or the like executes some or all of the actual processing to perform the functions according to the embodiments described above, based on instructions from the program code.

As described above, according to the present invention, a copy-forgery-inhibited pattern image including combined latent character strings can be generated without bothering the user so that the character strings are efficiently arranged.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-287654 filed Sep. 30, 2004, and No. 2005-275947 filed Sep. 22, 2005, which are hereby incorporated by reference herein in their entirety.

What is claimed is:

1. A data-processing apparatus for generating a copy-forgery-inhibited pattern image including a plurality of individual character strings, the data-processing apparatus comprising:
an accepting unit configured to accept specifications for the individual character strings;
a drawing-attribute accepting unit configured to accept specifications of drawing attributes for the individual character strings;
a calculating unit configured to calculate lengths of the individual character strings based on the specifications accepted by the accepting unit and the drawing-attribute accepting unit; and
a generating unit configured to generate character string lines by combining the individual character strings based on the lengths of the individual character strings calculated by the calculating unit.

2. The data-processing apparatus according to claim 1, wherein the generating unit is configured to change an arrangement order of the individual character strings based on the lengths of the individual character strings calculated by the calculating unit.

3. The data-processing apparatus according to claim 1, wherein the generating unit is configured to rotate at least one of the individual character strings 180 degrees.

4. The data-processing apparatus according to claim 1, wherein the generating unit is configured to compare a predetermined threshold value with the difference between the lengths of the longest and shortest individual character strings among the lengths of the individual character strings calculated by the calculating unit, and to determine whether the generating unit generates the character string lines by combining the individual character strings based on a result of the comparison.

5. The data-processing apparatus according to claim 1, wherein the generating unit is configured to set a predetermined amount of space between individual character strings in the character string lines.

6. The data-processing apparatus according to claim 1, wherein the generating unit is configured to generate at least two character string lines including the longest and shortest individual character strings.

7. The data-processing apparatus according to claim 1, wherein the generating unit is configured to change the drawing attributes based on the lengths of the individual character strings calculated by the calculating unit.

8. The data-processing apparatus according to claim 7, wherein the generating unit is configured to compare a predetermined threshold value with the ratio of the length of a character string line including the longest and shortest individual character strings to the length of another character string line including a combination of individual character strings other than the longest and shortest individual character strings, and to determine whether the generating unit changes the drawing attributes based on a result of the comparison.

9. The data-processing apparatus according to claim 7, wherein changing the drawing attributes includes changing a size of at least one of the individual character strings.

10. The data-processing apparatus according to claim 9, wherein the generating unit is configured to change the size of at least one of the individual character strings in a range of a predetermined lower limit size to a predetermined upper limit size.

11. A data-processing method for generating a copy-forgery-inhibited pattern image including a plurality of individual character strings, the data-processing method comprising:
an accepting step of accepting specifications for the individual character strings;
a drawing-attribute accepting step of accepting specifications of drawing attributes for the individual character strings;
a calculating step of calculating lengths of the individual character strings based on the specifications accepted in the accepting step and the drawing-attribute accepting step; and
a generating step of generating character string lines by combining the individual character strings based on the lengths of the individual character strings calculated in the calculating step.

12. The data-processing method according to claim 11, wherein the generating step comprises changing an arrangement order of the individual character strings based on the lengths of the individual character strings calculated in the calculating step.

13. The data-processing method according to claim 11, wherein the generating step comprises changing an orientation of at least one of the individual character strings 180 degrees.

14. The data-processing method according to claim 11, wherein the generating step comprises comparing a predetermined threshold value with the difference between the lengths of the longest and shortest individual character strings among the lengths of the individual character strings calculated in the calculating step, and determining whether the character string lines are to be generated by combining the individual character strings based on a result of the comparison.

15. The data-processing method according to claim 11, wherein the generating step comprises setting a predetermined amount of space between individual character strings in each of the character string lines.

16. The data-processing method according to claim 11, wherein the generating step comprises generating at least two character string lines including the longest and shortest individual character strings.

17. The data-processing method according to claim 11, wherein the generating step comprises changing the drawing attributes based on the lengths of the individual character strings calculated in the calculating step.

18. The data-processing method according to claim 17, wherein the generating step comprises comparing a predetermined threshold value with the ratio of the length of a character string line including the longest and shortest individual character strings to the length of another character string line including a combination of individual character strings other than the longest and shortest individual character strings, and determining whether the drawing attributes are to be changed based on a result of the comparison.

19. The data-processing method according to claim 17, wherein changing the drawing attributes includes changing a size of at least one of the individual character strings.

20. The data-processing method according to claim 19, wherein the generating step comprises changing the size of at least one of the individual character strings using a range of a predetermined lower limit size to a predetermined upper limit size.

21. A computer-readable medium having computer-readable instructions stored thereon for causing a computer to perform the data-processing method according to claim 11.

22. A copy-forgery-inhibited pattern image generating apparatus that generates a copy-forgery-inhibited pattern image including a plurality of character strings, the copy-forgery-inhibited pattern image generating apparatus comprising:
a generating unit configured to generate a third character-string group by combining a first character-string group including character strings arranged in decreasing order of length and a second character-string group including character strings arranged in increasing order of length with a predetermined amount of space between the first character-string group and the second character-string group; and
an arranging unit configured to generate the copy-forgery-inhibited pattern image by disposing the third character-string group generated by the generating unit like tiles on a predetermined area.

23. The copy-forgery-inhibited pattern image generating apparatus according to claim 22, wherein an orientation of either the first or second character-string group is rotated 180 degrees.

24. The copy-forgery-inhibited pattern image generating apparatus according to claim 23, wherein the generating unit is configured to change a size of at least one of the individual character strings based on the difference between lengths of the character strings.

25. The copy-forgery-inhibited pattern image generating apparatus according to claim 22, wherein the generating unit is configured to change a size of at least one of the individual character strings based on the difference between lengths of the character strings.

26. A copy-forgery-inhibited pattern image generating method for generating a copy-forgery-inhibited pattern image including a plurality of character strings, the copy-forgery-inhibited pattern image generating method comprising:
a generating step of generating a third character-string group by combining a first character-string group including character strings arranged in decreasing order of length and a second character-string group including character strings arranged in increasing order of length with a predetermined amount of space between the first character-string group and the second character-string group; and
an arranging step of generating the copy-forgery-inhibited pattern image by disposing the third character-string group generated in the generating step like tiles on a predetermined area.

27. The copy-forgery-inhibited pattern image generating method according to claim 26, wherein either the first or second character-string group is rotated 180 degrees.

28. The copy-forgery-inhibited pattern image generating method according to claim 27, wherein the generating step comprises changing sizes of the character strings based on the difference between lengths of the character strings.

29. The copy-forgery-inhibited pattern image generating method according to claim 26, wherein the generating step comprises changing sizes of the character strings based on the difference between lengths of the character strings.

30. An image-generating apparatus that generates an output pattern including a plurality of character strings, the image-generating apparatus comprising:
an accepting unit configured to accept input of a plurality of character strings;
a determining unit configured to determine a combination string including a plurality of character strings accepted by the accepting unit so that few gaps occur based on lengths of the individual character strings; and
a generating unit configured to generate the output pattern by repeatedly disposing the combination string determined by the determining unit.

31. An image-generating apparatus that generates a pattern including a plurality of character strings, the image-generating apparatus comprising:
an accepting unit configured to accept input of a plurality of character strings;
a determining unit configured to select at least one character string from the plurality of character strings accepted by the accepting unit so that a total length of the at least one character string is close to a reference length; and
an arranging unit configured to generate the pattern by disposing the at least one character string selected by the determining unit and disposing a character string other than the selected at least one character string so that a total length of the character string is close to the reference length.

32. An image-generating apparatus that generates a character-string pattern, the image-generating apparatus comprising:
an accepting unit configured to accept input of a plurality of character strings;
a determining unit configured to select one character string from the plurality of character strings accepted by the accepting unit as a character string to be used multiple times; and
a generating unit configured to generate the character-string pattern by disposing a plurality of copies of the character string selected by the determining unit.

33. A data-processing method for generating an output pattern including a plurality of character strings, the data-processing method comprising:
an accepting step of accepting input of a plurality of character strings;
a determining step of determining a combination string including a plurality of character strings accepted in the accepting step so that few gaps occur based on lengths of the character strings; and
a generating step of generating the output pattern by repeatedly disposing the combination string determined in the determining step.

34. A data-processing method for generating a pattern including a plurality of character strings, the data-processing method comprising:
an accepting step of accepting input of a plurality of character strings;
a determining step of selecting at least one character string from the plurality of character strings accepted in the accepting step so that a total length of the at least one character string is close to a reference length; and
an arranging step of disposing the at least one character string selected in the determining step and of disposing a character string other than the selected at least one character string so that a total length of the character string is close to the reference length.

35. A data-processing method for generating a character-string pattern, the data-processing method comprising:
an accepting step of accepting input of a plurality of character strings;
a determining step of selecting one character string from the plurality of character strings accepted in the accepting step as a character string to be used multiple times; and
a generating step of generating the character-string pattern by disposing a plurality of copies of the character string selected in the determining step.
